(19) United States
(12) Patent Application Publication
(10) Pub. No.: US 2003/0126092 A1
(43) Pub. Date: Jul. 3, 2003

(54) Individual authentication method and the system

(76) Inventor: Mitsuo Chihara, Tokyo (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/032,708

(22) Filed: Jan. 2, 2002

(51) Int. Cl. G06F 17/60

(52) U.S. Cl. 705/67

(57) ABSTRACT

The present invention provides an individual authentication method employing an authentication key which is capable of reliably preventing the illegal use of cards by others, and yet does not require special efforts by the card owner to memorize the same. This individual authentication method is capable of determining whether a card user is the true card owner by registering, together with a personal identification number, personal information relating to private data of the card owner in a device managed directly or indirectly by the card-issuing institution at the time of issuance of the card; randomly selecting for each transaction one or more questions from among a plurality of questions based on the personal information and requesting the card user to answer the questions upon using the card; and verifying the answer contents with the contents of the registered personal information for determining whether the card user is the true card owner.

### BACKGROUND OF THE INVENTION

1. Field of the Invention

The present invention relates to an individual authentication method suitably utilizable in transactions where personal identification is necessary as represented in transactions via bank automated teller machines.

2. Description of the Related Art

As examples of cards, there are cash cards and credit cards, cards used by individuals to operate the transaction terminals of financial institutions, membership cards representing one's qualification for using fitness clubs and various recreational facilities, among others, and cards are an indispensable presence in the contemporary society. When using such cards, personal identification; in other words, individual authentication is necessary to certify that the card user is the true card owner, and individual authentication utilizing an authentication device is therefore conducted. For example, with ATMs established in banks or the like, upon inserting the card and inputting one's personal identification number represented by a digit sequence, this personal identification number and the card ID are verified, and transactions such as the withdrawal of cash are thereby permitted only after the personal identification number is confirmed to be correct.

Nevertheless, the personal identification number represented in such digit sequence is difficult to remember, and, thus, a digit sequence easily suggestive to the card owner, such as a birth date or the like, is often selected as the personal identification number. This type of digit sequence can easily be figured out by others, and particularly, upon losing the likes of a driver's license indicating one's personal information, others will be able to easily figure out the personal identification number. Although this is preventable by selecting a digit sequence entirely insignificant to the card owner, this will in turn be difficult to remember, and errors in the personal identification number caused by wrong numbers will occur frequently when neglecting efforts to continuously memorizing the digit sequence.

### SUMMARY OF THE INVENTION

The present invention was devised in view of the foregoing situation, and provided is an individual authentication method employing an authentication key capable of reliably preventing the unauthorized use of cards by others, and which does not require special efforts by the card owner to memorize the same.

As a result of intense study, the inventors conceived using an authentication key based on personal information relating to the private data knowable only to the individual or his/her close relatives and which will not be forgotten. Since this type of authentication key is self evident to the individual, there is no need at all to consciously memorize the same, and it will not be burdensome on the individual even upon setting a plurality of authentication keys since he/she does not have to consciously memorize such keys. Thereby, by setting a plurality of authentication keys and enabling the use of different authentication keys per transaction, even if the user loses his/her card, this will be extremely safe since it will be nearly impossible for others to know such authentication keys. And it was considered that the style of answering questions is appropriate for the input of such authentication keys.

The present invention completed based on the foregoing concept is characterized by comprising the steps of registering, together with the personal identification number, personal information relating to private data of a card owner in a device managed directly or indirectly by the card-issuing institution at the time of issuance of the card; randomly selecting for each transaction one or more questions from among a plurality of questions based on the personal information and requesting the card user to answer the questions upon using the card; and verifying the answer contents with the contents of the registered personal information for determining whether the card user is the true card owner.

In the present invention, personal information is used as the authentication key in addition to the personal identification number used hitherto. Personal information as used herein includes subject matter of private information and having a conception antithetical to information used for officially specifying an individual with the likes of a driver's license and other identifications. With the present invention, among the private information, specifically used is personal information relating to private data knowable only to the individual or his/her close relatives. Here, the meaning of information knowable only to the individual or his/her close relatives does not mean information intended to be kept confidential. Needless to say, although the information may be intended as confidential, information knowable only to the individual or his/her close relatives implies that the information has not been assertively disclosed, or the disclosure itself has no significance. This type of personal information is registered in advance, the card user is asked to answer a question based on such personal information using the card, and individual authentication is conducted by examining the correctness of the answer. The same question is not used constantly, and a different question is used for each transaction.

Although the use of personal information as the authentication key for personal identification is the characteristic of this invention, it is not necessary to use personal information as the authentication key for every transaction. For example, transactions may be settled with only the personal identification number as conventionally without using personal information when the transaction amount is small or when the proportion of the transaction amount in the balance in account is small during transactions with financial institutions such as banks and credit card companies.

Moreover, although the number of questions presented upon using the card may be one or several, when there are a plurality of questions, for example, the number of questions may be increased pursuant to the rise in the importance of the transaction. The importance of the transaction may be judged by the absolute cost of the transaction amount, or judged by the proportion of the transaction amount in the balance in account.

Personal information is registered in advance at the time of issuance of the card, but various methods of registration may be used. For example, considered may be using the same questions used upon using the card as those used at the time of registration of the card.

It is preferable that the answer to the question adopt a multiple choice system. It is also preferable that a choice of no answer be provided in which one choice among the plurality of choices to the question is an answer that the answer to the question does not exist in the choices.

The question from the authentication device to the card user may be displayed on a display or made via artificial voice. Moreover, the response of the card user to the question may be selected on the display or made via voice with voice recognition.

Judgment of the question based on personal information and the correctness of the answer to such question is made upon referring to the database managing the personal information. From the perspective of increasing security, it is desirable that the personal information database is structured independently from the personal identification number database, the computers managing such databases are also respectively separate and independent, and that the information communication between these databases is protected from unauthorized external access.

Although various styles of questioning may be considered, as an interesting example, for instance, a plurality of elements mutually relating to the personal information may be contained in a single question, and one meaningful event may be represented with the question by such plurality of elements being combined.

As a system for implementing such individual authentication method, in addition to the basic structure of a conventional individual authentication system, further provided may be a personal information database having recorded thereon personal information relating to the private data of the card owner; a question selection unit for randomly selecting a question to be used in the current case among the plurality of questions based on the personal information recorded in the personal information database; a question presentation unit for presenting the selected question to the card user and requesting the answer thereof; and an answer content determination unit for verifying the answer contents of the card user to the question with the contents of the personal information database and determining whether the card user is the card owner. Moreover, a system structure is also possible where the results of such answer content determination are utilized for judging whether to implement financial transactions and the like.

### BRIEF DESCRIPTION OF THE DRAWINGS

FIG. 1 is a block explanatory diagram of the portion relating to the authentication processing in the first embodiment of the individual authentication system of the present invention;

FIG. 2 is a flowchart showing the flow of the authentication processing in the first embodiment of the present invention;

FIG. 3 is an explanatory diagram showing the flow of the authentication processing which separates the case of combining and not combining questions concerning personal information depending on the transaction amount;

FIG. 4 is an explanatory diagram showing examples of the questions and answers;

FIG. 5 is an explanatory diagram showing an example of a method of registering personal information;

FIG. 6 is an explanatory diagram showing an example of a question displayed on the display device upon using the card; and

FIG. 7 is an explanatory diagram showing an example of a system when structuring the personal identification number database and personal information database separately, and establishing the computers controlling such databases independently.

### DESCRIPTION OF THE PREFERRED EMBODIMENTS

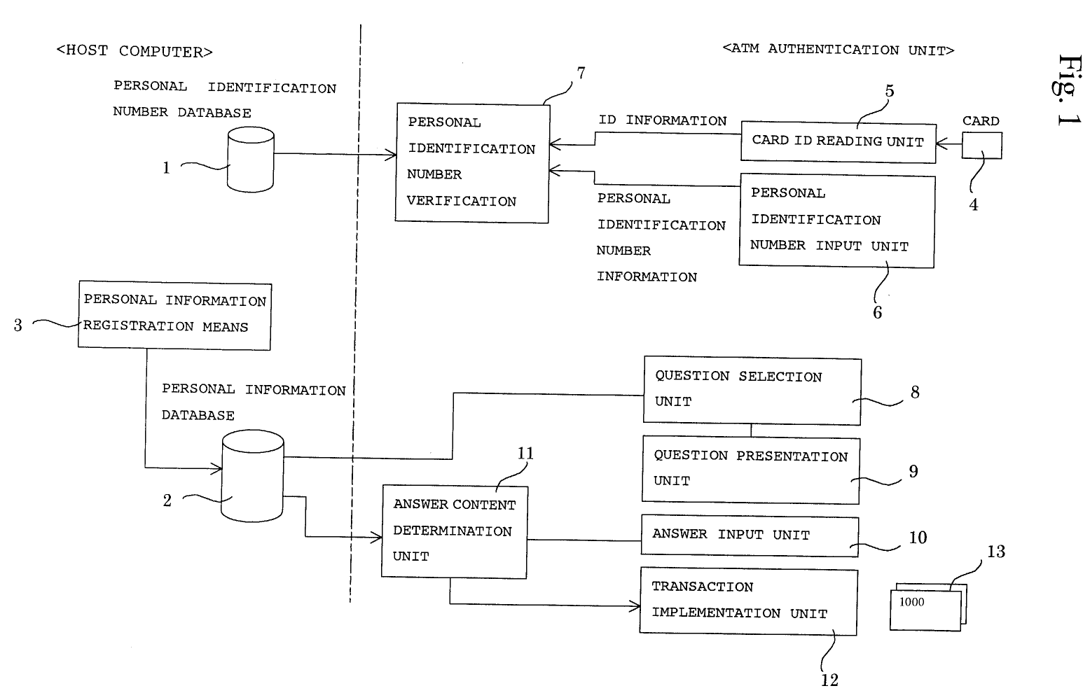

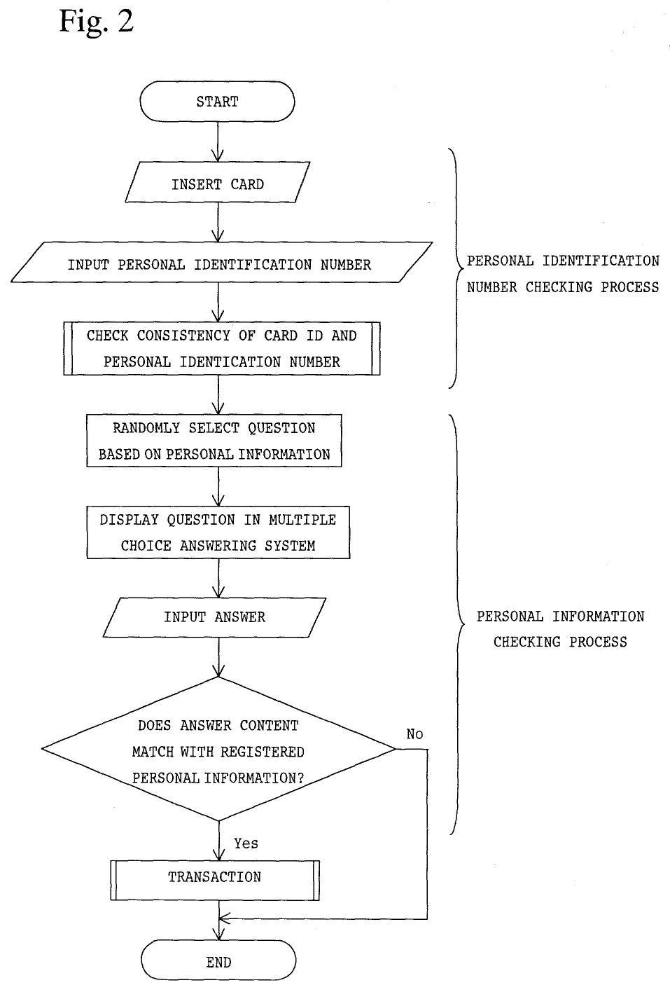

Next, details of the present invention are explained based on the illustrated embodiments. FIG. 1 is a block diagram showing an outline of a case of employing the present invention in an individual authentication system using an ATM (automated teller machine). Similar to this type of conventional system, the present system is also structured of an ATM as the authentication terminal established in the likes of a branch office of a bank, and a host computer connected to such ATM with a communication circuit. FIG. 1 is an abstraction and representation of the portion relating to the authentication mechanism in the system, and the right half of the diagram is the portion provided to the ATM side (hereinafter referred to as the ATM side authentication unit), and the left half of the diagram is the portion provided to the host computer (hereinafter referred to as the host computer side authentication unit). The ATM side authentication unit comprises a portion for processing the personal identification number and a portion for processing the questions based on personal information. Meanwhile, the host computers side authentication unit comprises a personal identification number database 1 having recorded thereon the correspondence relationship of the personal identification number and the card ID and a personal information database 2 having recorded thereon personal information of the card owner. The personal identification number database 1 and the personal information database 2 may be provided independently, or integrally. Registration of personal information in the personal information database 2 is conducted with a personal information registration means 3 provided in a timely manner. The registration method of personal information will be described later.

The portion for processing the personal identification number provided on the ATM side comprises a card ID reading unit 5 for reading the card ID from the inserted card 4, a personal identification number input unit 6 for inputting the personal identification number, and a personal identification number verification unit 7. The personal identification number verification unit 7 examines the consistency of the ID information read by the card ID reading unit 5 and the personal identification number input from the personal identification number input unit 6 through verification with the recorded contents of the personal identification number database 1 provided on the host computer side. Although personal identification may be conducted by recording the personal identification number in the card 4 and examining the consistency of the personal identification number within the card 4 and the personal identification input from the personal identification number input unit 6, with this method, it is not possible to prevent the unauthorized use of cards when the personal identification number within the card is read in one way or another. Thus, in the present embodiment, the personal identification number is not recorded in the card, and a card ID is recorded instead of the personal identification number.

The portion for processing the questions based on personal information provided to the ATM side comprises a question selection unit 8 for randomly selecting questions for each transaction from the recorded contents accumulated in the personal information database 2, a question presentation unit 9 for presenting such selected questions to the card user, an answer input unit 10 for the card user to input answers to such presented questions, an answer content determination unit 11 for verifying the recorded contents and the like of the personal information database 2 with respect to the input answer contents and determining the correctness thereof, and a transaction implementation unit 12 for conducting the withdrawal or the like of cash 13 when it is confirmed that the user is the true owner of the card as a result of such determination. Here, although the answer content determination unit 11 is provided to the ATM side, the answer content determination unit 11 may be provided to the host computer side such that the contents of the determination unit are sent to the ATM side.

Cards used in the present invention include all cards used for individual authentication such as magnetic cards, IC cards, optical cards, and so on. The question selection unit 8 presents a question randomly such that the question differs for each transaction. It is important that the questions are presented randomly, but, in consequence, this does not preclude the previous questions from being presented again. A question may be presented as is from the contents recorded in the personal information database 2, or a question may be arranged. The question presentation unit 9 may present the questions in various styles, but it is preferable that the presentation involves a screen display. It is also preferable that an artificial voice be used simultaneously to ask the questions. Use of touch panels and keyboards as well as the use of a voice input means may be considered for the answer input unit 10. The transaction implementation unit 12 is not limited to the withdrawal of cash, and includes all transactions implementable with ATMs such as balance inquiries.

The present invention is characterized in that personal information is used in addition to the personal identification number used hitherto as the authentication key for personal identification in transactions. The processing flow in this transaction is described below. Here, although the example is based on an ATM, the authentication device may be other devices; for example, a device for examining the authenticity of credit cards and membership cards.

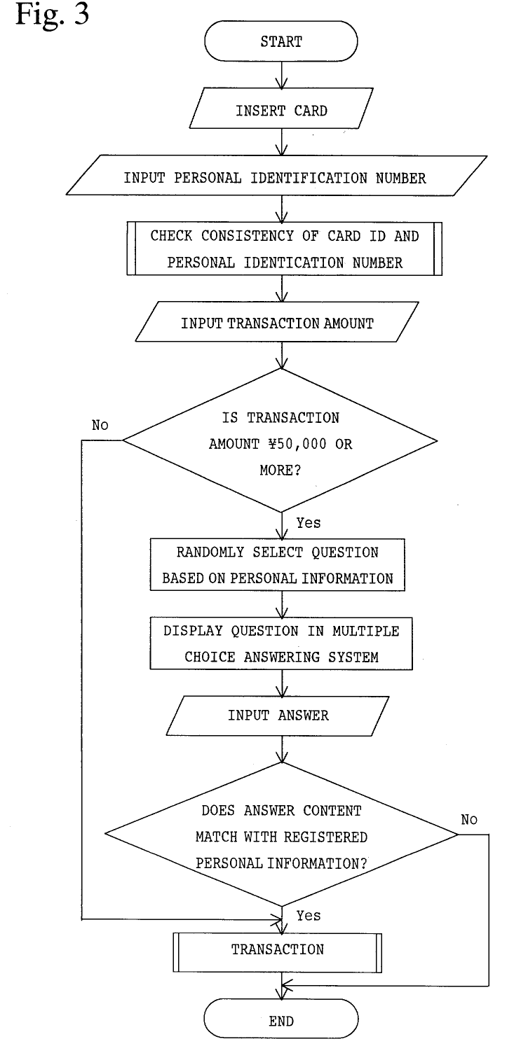

FIG. 3 is a flowchart showing the flow of authentication processing in the present invention. The authentication procedure is broadly classified into a personal identification number checking process and a personal information checking process, and transaction processing is implemented only for those in which personal identification is confirmed as a result of this authentication procedure. The transaction flow is as follows. Foremost, the card is inserted and the personal identification number is input, and, after the consistency check is performed for the card ID and the personal identification number, the routine proceeds to the personal information checking process.

In the personal information checking process, personal information is foremost read from the personal information database 2, and a question is randomly selected based on the read personal information. Since data of the questioning style is not recorded in the personal information database as is, simultaneously with the extraction of data, a question will be prepared based on the extracted personal information data. It is not necessary to ask the same questions constantly based on the same personal information, and different questions may be prepared.

Next, the prepared question is displayed in a multiple choice answering system, and the card user is requested to input the number of the answer to the question. Here, although a multiple choice answering system is employed in order to save the labor of inputting answers, a method of inputting sentences; that is, a free answer system may be adopted even if the answer is atypical so as long as the meaning thereof can be analyzed. In such a case, the use of a voice input means comprising a voice recognition function may be considered as the input system of free answers. When the card user inputs the answer number, examined is whether the answer contents are consistent with the registered personal information, and the transaction processing is implemented when consistent. Meanwhile, the transaction processing is rejected when inconsistent. Described here is a case of always using the personal information in combination with the personal identification number, but it would be possible to only use the personal for transactions of great importance, and to settle ordinary transactions will only the personal identification number. A transaction of great importance as referred to herein, in the case where the authentication device is an ATM, indicates cases where the absolute cost of the transaction amount is large or when the proportion of the transaction amount in the balance in account is large. FIG. 3 shows an example of this, and a question based on personal information is simultaneously used in cases where the transaction amount is ¥50,000 or more, and the transaction is settled with only the checking of the personal identification number in cases where the transaction amount is less than ¥50,000. Moreover, a plurality of questions based on personal information may be presented, and, for instance, a preferable example would be where the number of questions is increased pursuant to the increase in the absolute cost of the transaction cost or the proportion of the transaction amount in the balance in account.

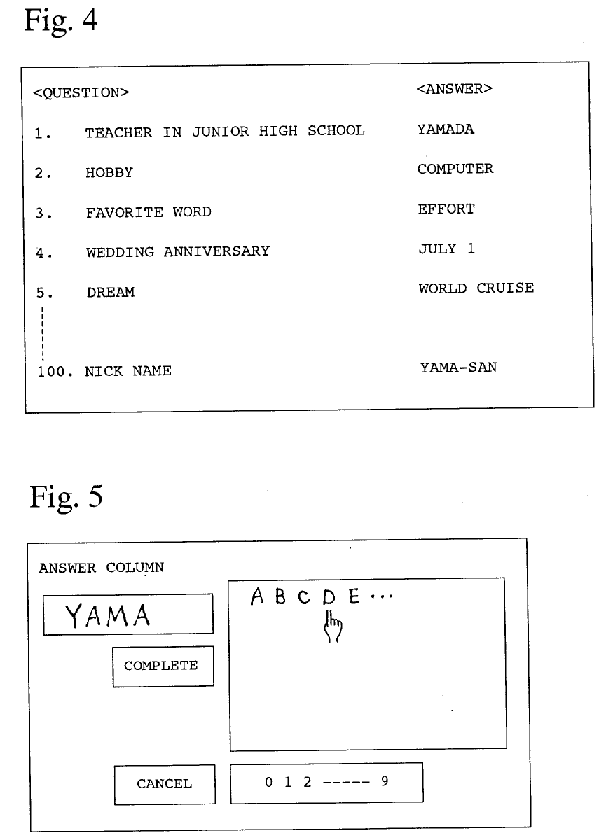

Personal information as used in the present invention refers to information relating to private data knowable only to the individual or his/her close relatives and which will not be forgotten. As such personal information, for example, considered may be “Name of former teacher in junior high school” or “Favorite word” or the like. FIG. 4 exemplifies the style of displaying these questions and the answers thereof, and shows that the answer “Yamada” corresponds to the question “Former teacher in junior high school” and the answer “computer” corresponds to the question “Hobby”. Such personal information is registered simultaneously upon registering the personal identification number at the time of issuance of the card. Although the personal information will be registered simultaneously at the time the personal identification number is registered, there are cases where the personal information database and the personal identification number database are integrated, and cases of structuring independent databases in order to lay particular emphasis on the aspect of security.

FIG. 5 exemplifies a method of registering personal information, and shows the state of the user inputting text by selecting alphabets displayed on the screen. Since the answers to the questions are free answers in this diagram, the method of inputting answers with alphabets is adopted. Nevertheless, answers to the questions may be selected among formulaic examples of answers, and, in such a case, it would suffice to simply provide a means for selecting the relevant number instead of inputting alphabets.

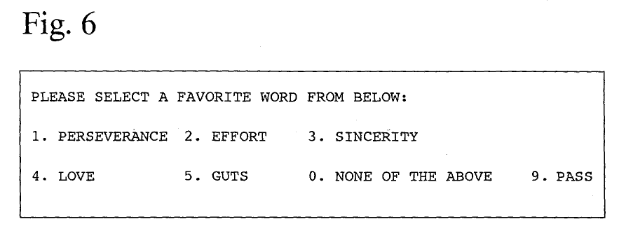

The personal information registered as described above is used for judging whether the answers to the questions presented at the time of using the card are correct or incorrect. The style of presenting the questions to the card user is not particularly limited so as long as the answer contents thereof can be verified with the registered personal information. FIG. 6 shows the simplest example of questioning. Here, shown is a state where the question “Please select a favorite word from below” is displayed on a display device comprising a pressure-sensitive means such as a touch panel, and “1. Perseverance 2. Effort 3. Sincerity 4. Love 5. Guts 0. None of the above 9. Pass” are displayed as the answer candidates thereof. The reason “None of the above” is included in the answer candidates is because there may be cases where there is no answer to the question, and the scope of the answer to the question may be broadened, thereby making it difficult for others to accidentally discover the correct answer. Further, when adopting a multiple choice system of selecting one among the plurality of candidates prepared in advance and not the free answer system upon registering the personal information, there is an advantage in that the system can address the situation even when a candidate to be selected was not included in the answer candidates. Moreover, the reason “Pass” is provided in the answer candidates is to address the situation where the card owner happens to forget his/her personal information. Since the personal information used in this system is private data unforgettable for the individual, “Pass” is not necessarily required, but the provision thereof will prevent the true card user from encountering unwanted trouble. However, when “Pass” is selected, it is necessary to present a different question to be answered such that the user cannot refuse to answer such question. It is also necessary to limit the number of times “Pass” may be used to a single occasion.

The questions based on the same personal information may always be the same, but may also be different. As a method of differing the question, for example, the order of answer candidates may be switched such as “1. Sincerity 2. Guts 3. Perseverance 4. Effort 5. Love 0. None of the above 9. Pass” such that the answer number is different for each transaction even if it is the same question, or the same question contents may be asked in a different style. However, from the perspective of avoiding psychological confusion of the true card owner, who is the answerer, it is preferable that the same questioning style as the questioning style employed at the time of registering the personal information be adopted. The example shown in FIG. 6 depicts a case where one type of personal information is included in one question. Nevertheless, for instance, an interesting example would be to represent a single meaningful event by including a plurality of mutually relating personal information in the question such as “My first date was with “15-year old” “Hanako Yamada” from “Tokyo”.

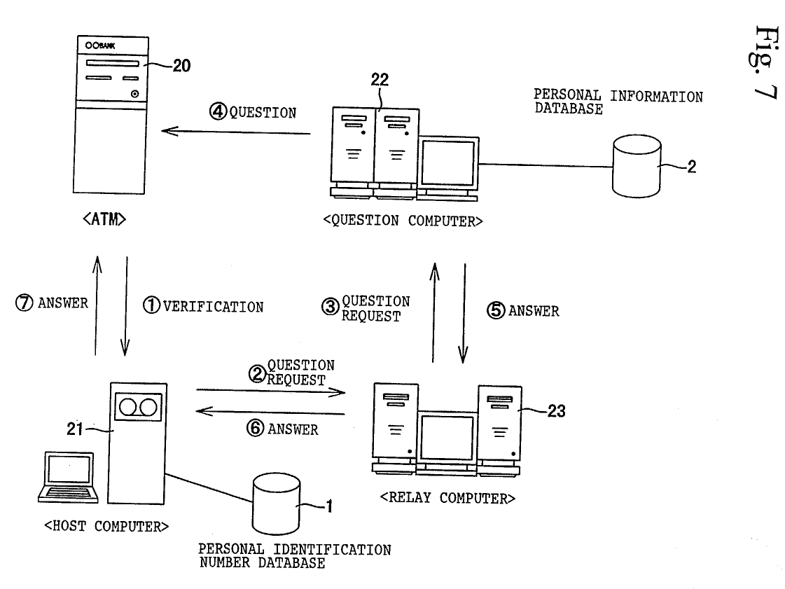

It has been described above that it would be preferable to separate the personal identification database and the personal information database from the perspective of laying emphasis on security, and FIG. 7 illustrates an example thereof. Here, in order to further increase security, the computer managing the personal information database and the computer managing the personal identification number database have been provided independently, and a relay computer which has no concern with the data contents managed by both computers is intervening therebetween. That is, as shown in FIG. 7, in addition to the ATM 20 and the host computer 21 managing the personal identification number database 1, provided are a question computer 22 for managing the personal information database 2 as well as presenting questions and a relay computer 23. Here, the relay computer 23 plays a filter-like role of completely separating the information relating to the personal identification number and the information relating to personal information, and forwards information sent from either the host computer 21 or the question computer 22 to the other side without concern to the contents thereof. This is a protective measure for preventing unauthorized external intrusion. The authentication procedure in this embodiment is conducted in accordance with the order of the numbers attached to the arrows in the drawing. The processing flow thereof is as follows.

[1] When a card is inserted into the ATM 20, the personal identification number is input and the transaction amount is input, verification of individual authentication from the ATM 20 to the host computers 21 is commenced.

[2] Authentication is completed with only the verification of the personal identification number when the transaction amount is less than a fixed amount, but the host computer 21 requests the relay computer 23 to present a question based on personal information when the transaction amount exceeds a fixed amount. Moreover, upon requesting the presentation of a question to the relay computer 23, a card owner code specified by the host computer 21 is also forwarded.

[3] The relay computer 23 receiving the request to present a question forwards such request as is to the question computer 22.

[4] The question computer 22 receiving the question request selects personal information relating to the card owner among the recorded contents of the personal information database 2 which it manages, and directly sends a question based thereon to the ATM 20.

[5] The question computer 22 sends to the relay computer 23 the correct answer to the question presented to the ATM 20.

[6] The relay computer 23 directly sends to the host computer 21 the answer to the question received from the question computer 22.

[7] The host computer 21 sends to the ATM 20 the correct answer it received.

All information necessary in determining the correctness of the authentication key input by the card user is thereby gathered in the ATM 20, and the ATM 20 examines whether the card user is the true card owner based on such information.

In this embodiment, since the personal identification number database and the personal information database are structured separately and independently, and the computers managing such databases are also structured independently, and a relay computer 23 comprising a protection means against unauthorized intrusion is further disposed between both such computers, the security thereof is extremely high.

The individual authentication method of the present invention uses personal information relating to private data of the card holder as the authentication key, and, in addition to registering such personal information in advance, a question to be used among the plurality of questions based on the registered personal information is randomly selected for each transaction when the card is used. As described above, with the present invention, since a question is selected randomly per transaction and the question contents to be answered change, it is impossible for others to predict the correct answer to the question in advance, and the unauthorized used of cards by others may be prevented with near certainty. In addition, since private data unforgettable to the individual is used as the authentication key, no effort is required by the card owner to memorize the authentication key even when there are numerous questions or when the question contents change.

Moreover, when the card is a card issued by a financial institution, and the number of questions to be selected at the time of using the card is increased pursuant to the increase in the absolute cost of the transaction amount or the proportion of the transaction amount in the balance in account, the security of transactions can be managed in more detail, thus yielding added security.

When the same questions as the questions used at the time of using the card are used upon registering personal information at the time of issuance of the card, since the card user has experienced the same questions when the card was issued, he/she will be able to answer the questions at ease without bewilderment upon using the card.

When the answer to the question is prepared in a multiple choice system, it is not necessary to adopt a complex input method as in a free answer system, and the answer may be completed with only the selection of a number.

When providing a choice of no answer in which one choice among the plurality of choices to the question is an answer that the answer to the question does not exist in the choices, the scope of the answer to the question is broadened, and it becomes difficult for others to accidentally discover the correct answer.

When the question and/or the response thereto is made by voice, there is no need to manually perform the input operation of the authentication key.

When the card is a card issued by a financial institution, and personal information is not used as the authentication key and only the personal identification number is used when the transaction amount is less than a fixed amount or when the proportion of the transaction amount in the balance in account is less than a fixed percentage, transactions of low importance can be facilitated pursuant to the actuality since questions based on personal information and answers thereof will not be required.

When the database relating to the personal identification number and the database relating to personal information are managed respectively by separate and independent computers, and the information communication between these databases is protected from unauthorized external access, even if the computer managing the personal identification database or the computer managing the personal information is illegally accessed, for example, the security of the overall transaction is guaranteed since the security of the remaining computer is maintained.

When a plurality of elements mutually relating to the personal information are contained in a single question, and one meaningful event is represented with the question by such plurality of elements being combined, the authentication key will be memorized even more distinctly since the question contents will be meaningful.

What is claimed is:

1. An individual authentication method, comprising the steps of: registering, together with the personal identification number, personal information relating to private data of a card owner in a device managed directly or indirectly by the card-issuing institution at the time of issuance of a card; randomly selecting for each transaction one or more questions from among a plurality of questions based on said personal information and requesting the card user to answer said questions upon using the card; and verifying the answer contents with the contents of said registered personal information for determining whether the card user is the true card owner.

2. An individual authentication method according to claim 1, wherein said card is a card issued by a financial institution, and the number of questions selected upon using the card is set to increase pursuant to the increase in absolute amount of the transaction or in proportion of the transaction amount in the balance in account.

3. An individual authentication method according to claim 1 or claim 2, wherein the same questions as the questions used upon using the card are used during the personal information registration conducted at the time of issuance of the card.

4. An individual authentication method according to any one of claims 1 to 3, wherein answers to the questions are prepared in a multiple choice system.

5. An individual authentication method according to claim 4, wherein the plurality of choices to each question includes a choice of no right answer, to indicate that there is no right answer to the question in the choices.

6. An individual authentication method according any one of claims 1 to 5, wherein one or both of the question and the response thereto is made by voice.

7. An individual authentication method according to claim 1, wherein said card is a card issued by a financial institution, and when the transaction amount is less than a predetermined amount or when the proportion of the transaction amount in the balance in account is less than a predetermined percentage, personal information is not used as the authentication key and only the personal identification number is used.

8. An individual authentication method according to any one of claims 1 to 7, wherein the database relating to the personal identification number and the database relating to personal information are managed respectively by separate and independent computers, and the information communication between these databases is protected from unauthorized external access.

9. An individual authentication method according to any one of claims 1 to 8, wherein a single question contains a plurality of mutually relating elements of the personal information, so that one meaningful event is represented with the question by combining such plurality of elements.

10. An individual authentication system comprising an authentication terminal for a card user to insert a card and input the authentication key for receiving individual authentication upon using the card, and a host computer for conducting authentication of the card user upon receiving information from said authentication terminal and returning the authentication results to said authentication terminal,
said individual authentication system further comprising:
a personal information database in which is recorded personal information relating to the private data of the card owner;
a question selection unit for randomly selecting a question to be used for current transaction among the plurality of questions based on the personal information recorded in said personal information database;
a question presentation unit for presenting said selected question to the card user and requesting the answer thereto; and
an answer content determination unit for verifying the answer contents of the card user to said question with the contents of said personal information database and determining whether the card user is the true card owner.
